(19) United States
(12) Patent Application Publication
(10) Pub. No.: US 2025/0377554 A1
(43) Pub. Date: Dec. 11, 2025

(54) Method of Making Eyewear Having Flexible Bridge Portion

(71) Applicant: Brent SHELDON, Miami Beach, FL (US)

(72) Inventor: Guy BROUSSEAU, Marieville (QC)

(73) Assignee: Brent SHELDON, Miami Beach, FL (US)

(21) Appl. No.: 19/307,429

(22) Filed: Aug. 22, 2025

Related U.S. Application Data
(63) Continuation of application No. PCT/CA2023/050387, filed on Mar. 23, 2023.
Application No. PCT/CA2023/050387 is a continuation-in-part of application No. PCT/CA2023/050232, filed on Feb. 24, 2023.

(51) Int. Cl. G02C 5/06; B29C 45/14; B29L 12/00

(52) U.S. Cl. CPC G02C 5/06; B29C 45/14467; B29L 2012/005; G02C 2200/16

(57) ABSTRACT

A method of making a flexible eyewear frame comprises arranging a first section and a second section in or adjacent to a flexible bridge mold, and injecting a flexible material into the flexible bridge mold to form a flexible bridge portion and connect the first and second sections.

### CROSS-REFERENCE TO RELATED APPLICATION(S)

This application is a Continuation of PCT Application No. PCT/CA2023/050387 filed on Mar. 23, 2023, which is a continuation-in-part of PCT Application No. PCT/CA2023/050232 filed on Feb. 24, 2023, the contents of which are hereby incorporated by reference in their entirety.

### TECHNICAL FIELD

The following generally relates to eyewear and, more particularly, to a method of making an eyewear frame having rigid sections joined with a flexible bridge portion.

### BACKGROUND

Conventional eyewear generally includes an eyewear frame with a head support apparatus and one or more lenses attached to the frame. For example, the eyewear frame may be made of substantially rigid plastic material and may be configured to define one or more lens openings for releasably engaging one or more lenses with the rigid frame. Such eyewear include a variety of eye glasses, such as sunglasses, protective work glasses, sport goggles, prescription eyewear, etc.

There is a demand for more varieties of eyewear to satisfy new functional requirements and fashion trends. For example, there is a need for eyewear of different styles such as eye glasses with a frame having flexibility to allow the frame curvature to automatically adjust to fit a user's face profile when worn by different users. However, a flexible frame may present issues for secure attachment of the lenses and, in particular for providing a solid support to prescription lenses in order to accurately meet very specific vision requirements.

### SUMMARY

In one aspect, there is provided a method of making a flexible eyewear frame, comprising: arranging a first section and a second section in or adjacent to a flexible bridge mold; and injecting a flexible material into the flexible bridge mold to form a flexible bridge portion and connect the first and second sections.

In certain example embodiments, the flexible material is formed over an extension projecting from each of the left and right sections.

In certain example embodiments, the flexible material is overmolded on the extensions.

In certain example embodiments, the flexible material comprises thermoplastic polyurethane (TPU).

In certain example embodiments, the method includes obtaining the left and right sections. The left and right sections may be premade. The method may include forming the left and right sections using a pre-assembly manufacturing process.

In certain example embodiments, the extensions each comprise a head portion.

In certain example embodiments, the extensions form a generally T-shape.

In certain example embodiments, the flexible bridge portion is formed to include a concave lower contour for placement on a user's nose.

In certain example embodiments, the method further includes incorporating a joining piece between the left and right sections prior to injecting the flexible material. The joining piece may be separate or integral with the left and right sections. The joining piece may also connect to and/or with extensions from the left and right sections.

In another aspect, there is provided a method of assembling eyewear, comprising: forming the flexible eyewear frame as defined above, removing the flexible eyewear frame from the mold; inserting a pair of lenses into the left and right sections to thereby create a non-flexible region in the eyewear; and attaching a pair of arms to the left and right sections at ends opposite the flexible bridge portion.

### BRIEF DESCRIPTION OF THE DRAWINGS

Embodiments will now be described with reference to the appended drawings wherein:

FIG. 1 is a perspective view of a flexible eyewear.

FIG. 2 is an exploded view showing substantially rigid left and right sections used to hold eyewear lenses.

FIG. 3 illustrates an example of a flexible bridge portion mold.

FIGS. 4 and 5 illustrate an example of a flexible eyeglasses frame showing detail of overmolded extensions.

FIG. 6 is a partial perspective view of a flexible eyeglasses frame.

FIG. 7 is a cross-sectional view of the flexible eyeglasses frame.

FIG. 8 is a flow chart illustrating operations performed in assembling a flexible eyeglasses frame using a mold such as that shown in FIG. 3.

FIG. 9 illustrates an example of a flexible bridge portion mold showing incorporation of a joining piece between the left and right sections prior to injecting a flexible material into the mold.

FIG. 10 illustrate another example of a flexible eyeglasses frame showing incorporation of the joining piece shown in FIG. 9.

FIG. 11 is a cross-sectional view of the flexible eyeglasses frame of FIG. 10.

FIG. 12 is a flow chart illustrating operations performed in assembling a flexible eyeglasses frame using a mold such as that shown in FIG. 9.

### DETAILED DESCRIPTION

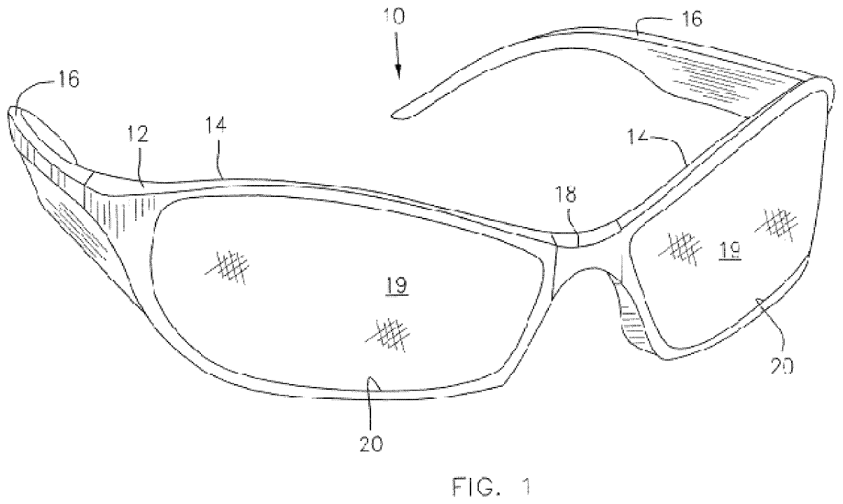

Referring to FIG. 1 which illustrates one embodiment of the described subject matter, eyewear for example, a pair of eyeglasses 10 includes a flexible eyeglasses frame 12. The flexible eyeglasses frame 12 in accordance with the embodiment generally includes a pair of right and left sections 14 (also referred to herein as “first” and “second” sections) of substantially rigid material (e.g., plastic, metal, composite materials, etc.) interconnected by a nose bridge portion 18 of a soft and/or flexible material such as a thermoplastic polyurethane (TPU) or other rubber material to form at least a front section (not numbered) of the eye glasses 10 when lenses 19 are attached thereto. The substantially rigid right and left sections 14 and the soft and/or flexible bridge portion 18 are joined together using a single molding process such as by overmolding as discussed further below. It can be appreciated that the left and right sections 14 may include any portion of a lens retainer and/or be combined with another section or portion to together form a lens retainer. As such, the left and right sections 14 may also be referred to herein as first and second or left and right rigid lens retainers.

Each of the right and left sections 14 according to this embodiment, may be configured to have a continuous inner peripheral edge 20 to define an opening (not numbered) for receiving the lens 19 which may be removably secured in the opening by clicking into a shallow annular groove (not shown) in the inner peripheral edge 20 which is known in the prior art and will not be further described herein. However, the right and left sections 14 of the flexible eyeglasses frame 12 may have other configurations and the lenses 19 may be attached to the respective right and left sections 14 in other known or unknown manners.

A head support mechanism such as a pair of arms or temples 16 is, for example, pivotally attached to an outer end of the respective right and left sections 14 of the flexible eye glasses frame 12, and may be made of a molding material similar to or different from the molding material of the substantially rigid right and left sections 14.

The substantially rigid right and left sections 14 provide secure attachment of the lenses 19 thereto and a solid structure for supporting the lenses 19 while the softness and/or flexibility of the flexible bridge portion 18 allows deformation such as bending or twisting such that flexible eyeglasses frame 12 can be automatically adjusted to the contours of multiple users faces.

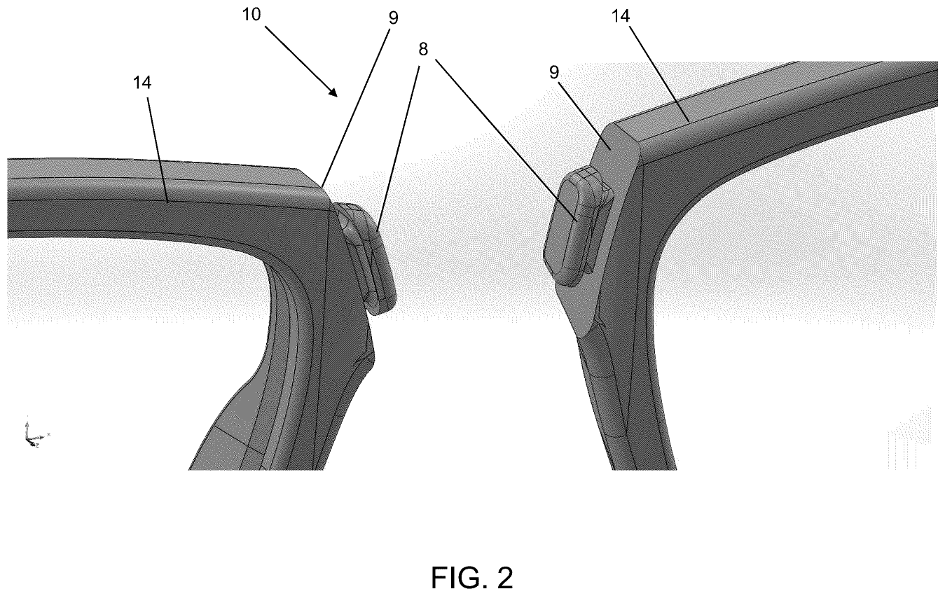

FIG. 2 illustrates the rigid right and left sections 14 prior to being formed with the flexible nose bridge portion 18. Each of the right and left sections 14 includes an extension 8, which in this example embodiment is generally T-shaped to permit a head portion thereof to provide additional contact surface area with the material used to mold the flexible bridge portion 18. It can be appreciated that the T-shape is purely illustrative and other shapes and contours can be used, including extensions 8 having a ball-shaped head, a Y-shaped head, etc. The extensions 8 protrude from a generally planar attachment surface 9 on a respective one of the left and right sections 14. The extent of the flexible bridge portion 18 is therefore defined by a spacing between the planar surfaces 9.

A manufacturing procedure is now described with reference to FIGS. 2-7. In this manufacturing procedure the substantially rigid right and left sections 14 of the flexible eyeglasses frame 12 and the soft and/or flexible nose bridge portion 18 are manufactured in a single molding process. Prior to this single molding process, it is appreciated that the rigid left and right sections 14 may be formed or may pre-exist and be provided to the manufacturing processing as supplied parts. For example, a molding material in a flowable condition may be injected into frame molds (not shown) to make separate right and left sections 14, the molding material for example may be a plastic material and becomes substantially rigid when it cures such that the right and left sections 14 of the flexible eyeglasses frame 12 form separate solid support structures for holding the respective lenses 19, such as prescription lenses, as shown in FIG. 1. The right and left sections 14 may be configured with various required features when they are cured in the pre-existing or preliminary molding process.

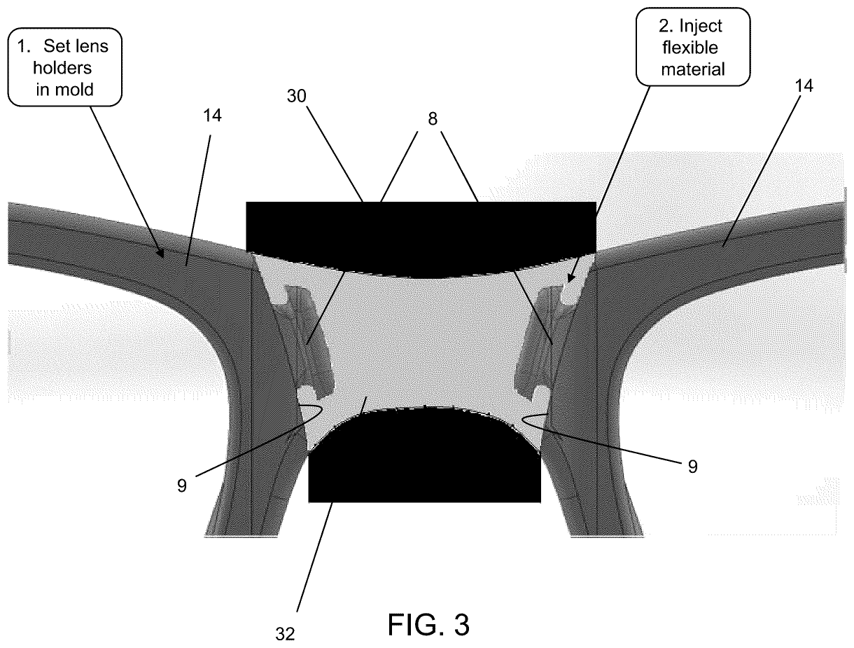

Referring now to FIG. 3, to form the flexible eyeglasses frame 12 to incorporate a flexible nose bridge portion 18, the substantially rigid left and right sections 14 are placed in a rig or otherwise set with or adjacent to a bridge mold 30 having a cavity 32 that defines the shape and contours of the desired flexible bridge portion 18. In this example, the sections 14 are arranged such that the planar surfaces 9 face towards the cavity 32 of the mold 30 and place the extensions 8 within the volume defined by the cavity 32 at Step 1. At Step 2, the flexible material used to form the flexible bridge portion 18 is injected into the cavity 32 of the mold 30 to effectively overmold the extensions 8 and in turn attach the left and right sections 14 to one another to form the flexible eyeglasses frame 12.

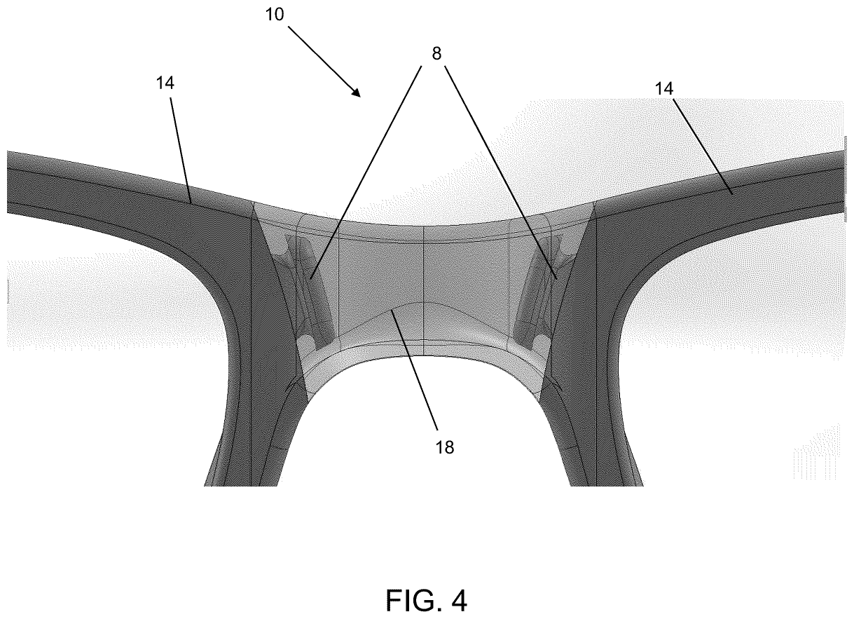

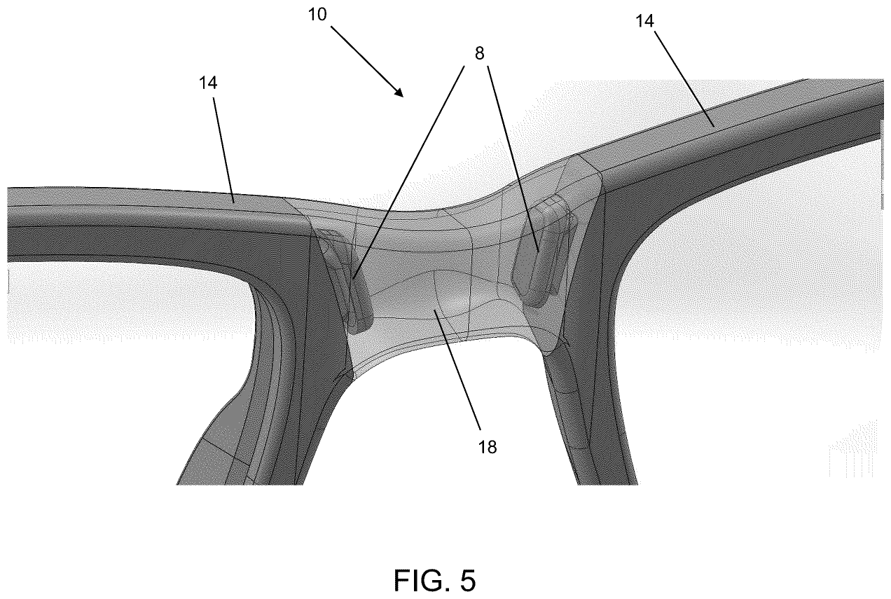

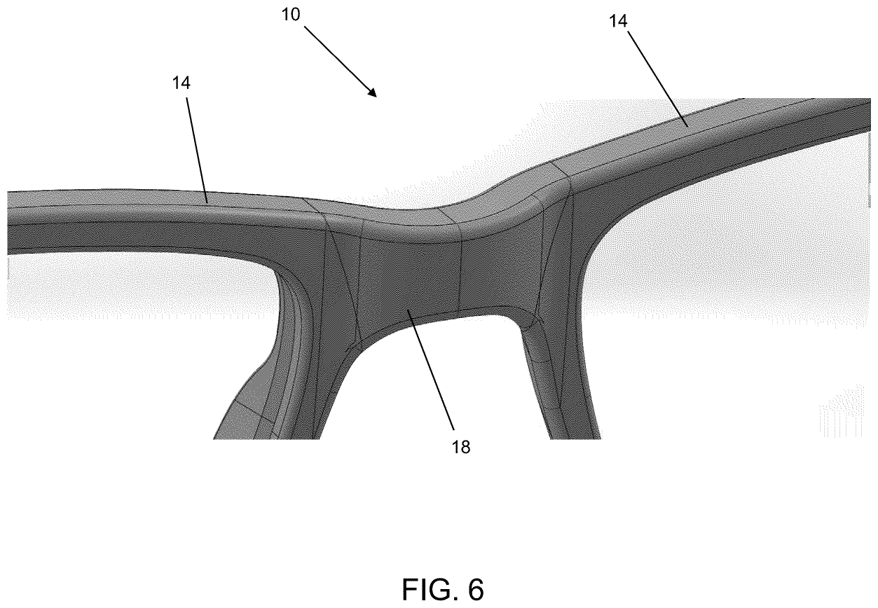

FIGS. 4 and 5 illustrate the resultant eyeglasses frame 12 with an overmolded flexible bridge portion 18 connecting the left and right sections 14 together. At the same time, the lower contour of the flexible bridge portion 18 permits the eyeglasses frame 12 to sit atop a user's nose. That is, a concave lower contour is formed for placement on a user's nose. FIGS. 4 and 5 provide translucent views of the extensions 8 projecting into the overmolded flexible bridge portion 18, however, it can be appreciated that the material used to form the flexible bridge portion 18 may be a solid material as shown in FIG. 6.

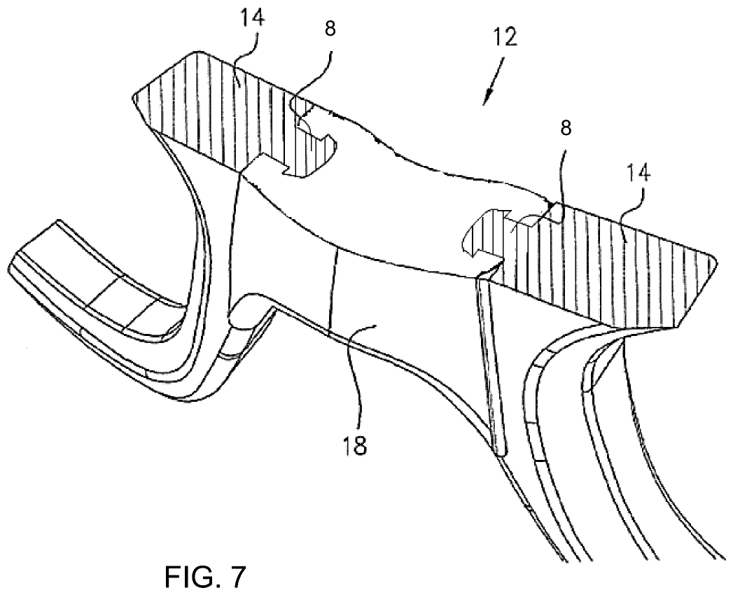

Referring now to FIG. 7, a cross-sectional view is shown to illustrate that the head portion of the extensions 8 provide additional surface area against which the material used to form the flexible bridge portion 18 can bond during the overmolding process.

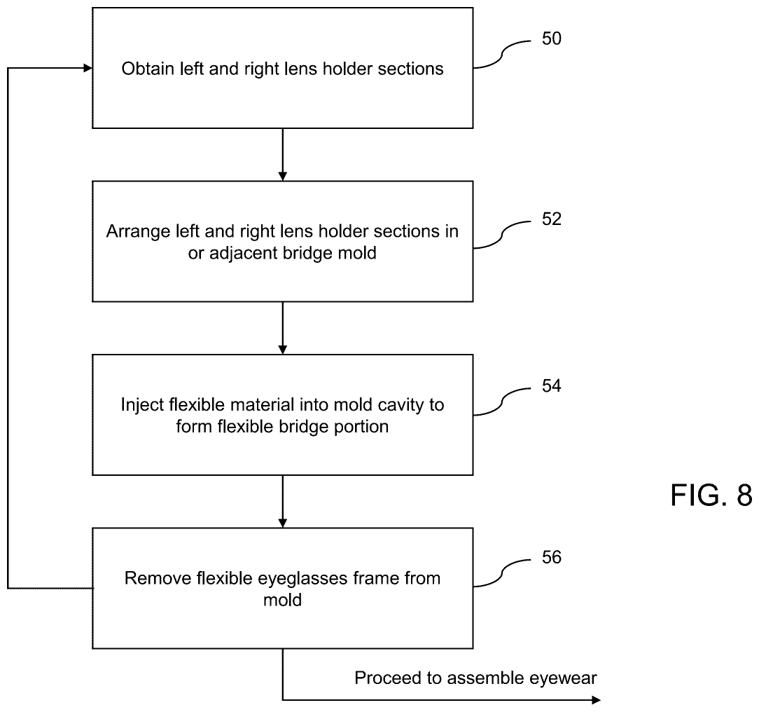

FIG. 8 illustrates operations that may be performed in conducting the manufacturing process described herein. At step 50, the substantially rigid left and right sections 14 are obtained, either by creating/molding them or by obtaining them as input parts to the process. At step 52, the left and right sections 14 are arrange in or adjacent to the bridge mold 30 as shown in FIG. 3. At step 54, the flexible material is injected into the mold cavity 32 to form the flexible bridge portion 18 as shown in FIGS. 4-7. At step 56, the resultant flexible eyeglasses frame 12 is removed from the mold 30 and the mold 30 can be used to form the next flexible eyeglass frame 12. From here, the eyewear 10 can be assembled by inserting lenses into the respective left and right sections 14 to thereby create a non-flexible region in the eyewear 10, as shown in FIG. 1. Additionally, the arms 16 may be attached to the left and right sections 14, if not already formed as part of the rigid sections.

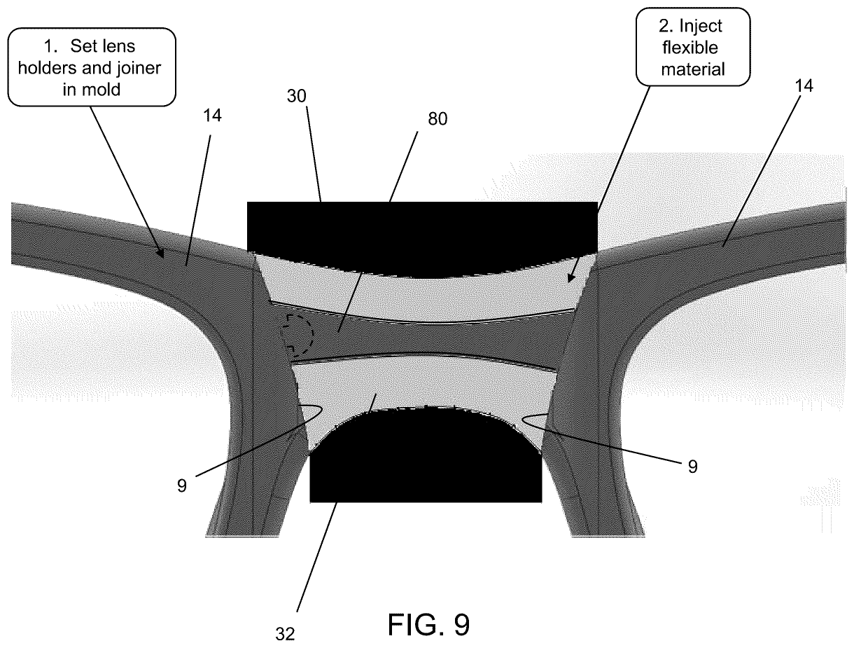

Referring now to FIGS. 9 to 12, another example embodiment is described in which a joining piece 80 is incorporated between the left and right sections 14. Similar to that described above with respect to FIG. 3, to form the flexible eyeglasses frame 12 that incorporates a flexible nose bridge portion 18, the substantially rigid left and right sections 14 are placed in a rig or otherwise set with or adjacent to a bridge mold 30 having a cavity 32 that defines the shape and contours of the desired flexible bridge portion 18. In this example, the sections 14 are arranged such that the planar surfaces 9 face towards the cavity 32 of the mold 30 and, in this example, a joining piece 80 is placed between the left and right sections 14 and within the volume defined by the cavity 32 at Step 1. At Step 2, the flexible material used to form the flexible bridge portion 18 is injected into the cavity 32 of the mold 30 to effectively overmold the joining piece 80 and in turn attach the left and right sections 14 to one another to form the flexible eyeglasses frame 12.

The joining piece 80 (also referred to herein as a connection piece or connection portion) is provided to connect the pair of left and right sections 14 and may be made of a similar or different material. The joining piece 80 may be provided integrally with or separately from the left and right sections 14. This may include attaching, fitting and/or bonding the joining piece 80 to the left and right sections 14. While not shown in FIG. 9, it can be appreciated that the joining piece 80 can also be adapted to fit on or with the extensions 8 shown in FIG. 3 (e.g., to fit together like puzzle pieces-one side shown as an optional feature using dashed lines in FIG. 9), such that the joining piece 80 can be added to an existing design such as that shown in FIG. 3. The joining piece 80 can be used to provide additional rigidity and/or additional surface area to which the flexible material 18 can bond. The joining piece 80 can be a deformable but rigid bar-like member. The joining piece 80 can be made from an elastically deformable metal that is capable of being bent while returning to its original shape. Due to its inherent rigidity, the piece 80 provides some strength to the flexible bridge portion 18 while being embedded within the otherwise flexible bridge portion 18 that may be overmolded as discussed above. In this way, the joining piece 80 can be chosen to have a thickness and material to fine tune the flexibility of the flexible bridge portion 18 while reforming to its original shape after being flexed as illustrated herein.

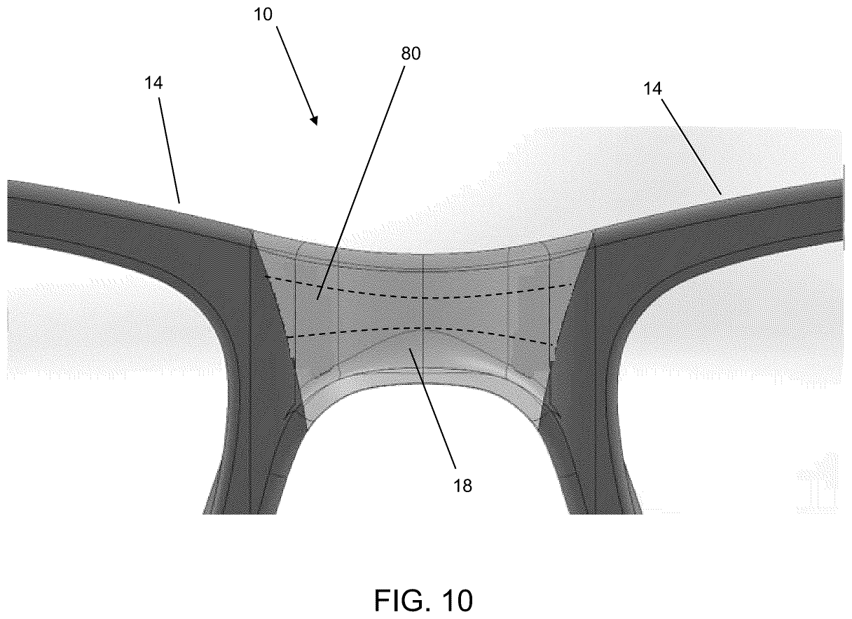

FIG. 10 illustrates the resultant eyeglasses frame 12 with an overmolded flexible bridge portion 18 connecting the left and right sections 14 together. At the same time, the lower contour of the flexible bridge portion 18 permits the eyeglasses frame 12 to sit atop a user's nose. That is, a concave lower contour is formed for placement on a user's nose. FIG. 10 provides a translucent view of the joining piece 80 extending between the sections 14 and within the overmolded flexible bridge portion 18, however, it can be appreciated that the material used to form the flexible bridge portion 18 may be a solid material as shown in FIG. 6.

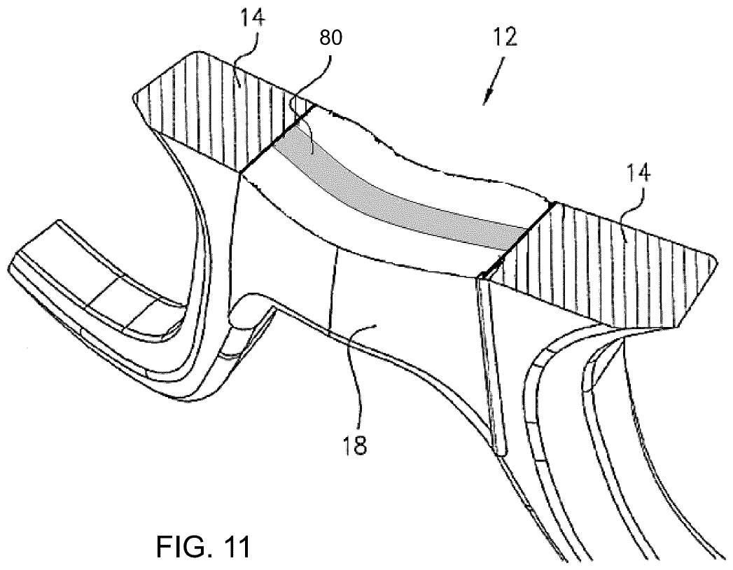

Referring now to FIG. 11, a cross-sectional view is shown to illustrate that the joining piece 80 provides additional surface area against which the material used to form the flexible bridge portion 18 can bond during the overmolding process.

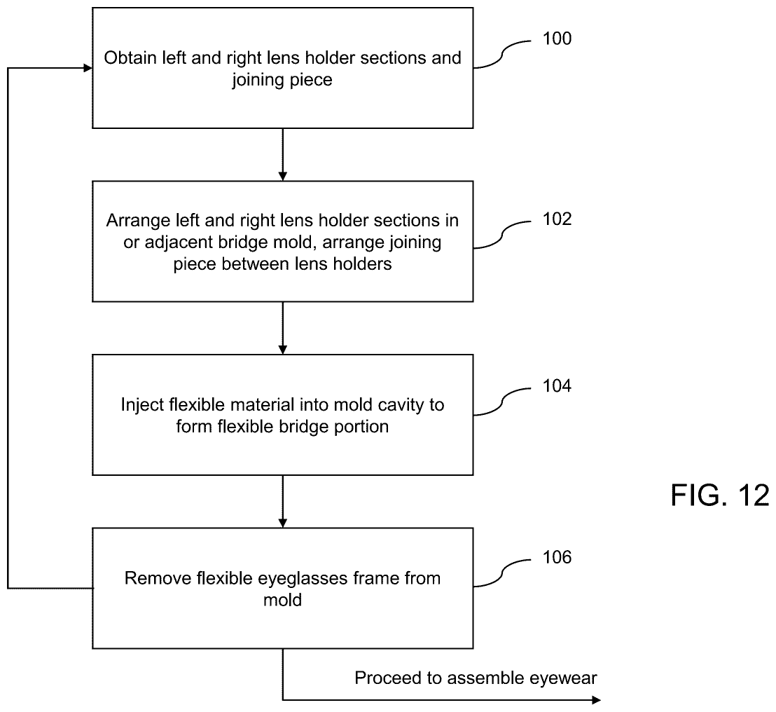

FIG. 12 illustrates operations that may be performed in conducting the manufacturing process described herein to produce the eyewear shown in FIGS. 9-11. At step 100, the substantially rigid left and right sections 14, and the joining piece 80, are obtained, either by creating/molding them or by obtaining them as input parts to the process. At step 102, the left and right sections 14 are arranged in or adjacent to the bridge mold 30 as shown in FIG. 9 and the joining piece 80 is placed or is at the same time placed within the mold 30 (e.g., if integral or bonded to the sections 14). At step 104, the flexible material is injected into the mold cavity 32 to form the flexible bridge portion 18 as shown in FIGS. 9-11. At step 106, the resultant flexible eyeglasses frame 12 is removed from the mold 30 and the mold 30 can be used to form the next flexible eyeglass frame 12. From here, the eyewear 10 can be assembled by inserting lenses into the respective left and right sections 14 to thereby create a non-flexible region in the eyewear 10, as shown in FIG. 1. Additionally, the arms 16 may be attached to the left and right sections 14, if not already formed as part of the rigid sections.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

1. A method of making a flexible eyewear frame, comprising:
arranging a first section and a second section in or adjacent to a flexible bridge mold; and
injecting a flexible material into the flexible bridge mold to form a flexible bridge portion and connect the first and second sections.

2. The method of claim 1, wherein the flexible material is formed over an extension projecting from each of the left and right sections.

3. The method of claim 1, wherein the flexible material is overmolded on the extensions.

4. The method of claim 1, wherein the flexible material is formed over a joining piece extending between the left and right sections.

5. The method of claim 4, wherein the joining piece is attached to the left and right sections or is integral therewith.

6. The method of claim 1, further comprising obtaining the left and right sections.

7. The method of claim 6, wherein the left and right sections are premade.

8. The method of claim 6, further comprising forming the left and right sections using a pre-assembly manufacturing process.

9. The method of claim 4, further comprising obtaining the left and right sections and the joining piece.

10. The method of claim 9, wherein the left and right sections and the joining piece are premade.

11. The method of claim 2, wherein the extensions each comprise a head portion.

12. The method of claim 11, wherein the extensions form a generally T-shape.

13. The method of claim 12, wherein the generally T-shape creates a mechanical bond or an interference fit when assembled with the flexible bridge.

14. The method of claim 1, wherein the flexible bridge portion is formed to include a concave lower contour for placement on a user's nose.

15. A method of assembling eyewear, comprising:
forming the flexible eyewear frame according to claim 1;
removing the flexible eyewear frame from the mold;
inserting a pair of lenses into the left and right sections to thereby create a non-flexible region in the eyewear; and
attaching a pair of arms to the left and right sections at ends opposite the flexible bridge portion.
